(19) United States
(12) Patent Application Publication
(10) Pub. No.: US 2016/0364038 A1
(43) Pub. Date: Dec. 15, 2016

(54) OPTICAL SENSING ELECTRONIC DEVICE AND OPTICAL SENSING METHOD

(71) Applicant: Wistron Corp., New Taipei City (TW)

(72) Inventor: Yu-Yen CHEN, New Taipei City (TW)

(21) Appl. No.: 14/920,771

(22) Filed: Oct. 22, 2015

(30) Foreign Application Priority Data
Jun. 12, 2015 (TW) 104119028

(51) Int. Cl. G06F 3/042

(52) U.S. Cl. CPC G06F 3/042

(57) ABSTRACT

The present invention provides an optical sensing electronic device including first, second, third and fourth image-sensing devices. The first, second, third and fourth image-sensing devices capture images of a rectangular area from different directions to produce a first, second, third and fourth image signal. The first, second, third and fourth image-sensing devices are disposed on a first side of a first edge of the rectangular area, the first and second image-sensing devices are disposed on a first horizontal line, the third and fourth image-sensing devices are disposed on a second horizontal line, and there is a first distance between the first horizontal line and the second horizontal line.

### CROSS REFERENCE TO RELATED APPLICATIONS

This application claims priority of Taiwan Patent Application No. 104119028, filed on Jun. 12, 2015, the entirety of which is incorporated by reference herein.

### BACKGROUND OF THE INVENTION

Field of the Invention

The present invention is related to an optical sensing electronic device; in particular to an optical sensing electronic device that is flexible regarding the area that can be detected.

Description of the Related Art

Due to their ease of use and intuitive controls, touch screen electronic devices have become mainstream devices that consumers look for in the current market. With previous touchscreen technology, among resistive, capacitive, and backlit technologies, capacitive screens have had the best results, however, due to the most expensive costs and the direct relationship between manufacturing cost and screen size, the use of capacitive screen technology is limited. In the search for an alternative to capacitive technology, a new technology has emerged that uses an optical lens to detect the position of physical contact with the screen. This optical lens technology costs little while maintaining a high accuracy, and in a competitive market, it is among the top consumer pick, becoming the technology of choice for large touch screens.

Another optical-lens touch screen technology uses an optical lens or reflective frame, capturing images of the user's finger motion on the screen and analyzing the shades that fingers create in the images to pinpoint the position of the finger, and thus the touch on the screen. Therefore in optical-lens touch screens, the touch-detection module must be set according to the screen size, starting at the corner of the screen. In other words, the touch-detection module must be preset in the electronic device.

### BRIEF SUMMARY OF THE INVENTION

A detailed description is given in the following embodiments with reference to the accompanying drawings.

One aspect of the present invention provides an optical sensing electronic device. The optical sensing electronic device includes a first image-sensing device, a second image-sensing device, a third image-sensing device, a fourth image-sensing device, and a computing device. The first image-sensing device captures images of a rectangular area from a first direction to produce a first image signal, wherein the rectangular area has four edges, and each of the edges has two sides. The first image-sensing device is disposed on a first side of a first edge of the rectangular area. The second image-sensing device captures images of the rectangular area from a second direction to produce a second image signal, wherein the second image-sensing device is disposed on the first side of the first edge of the rectangular area, and the first image-sensing device and the second image-sensing device are disposed on a first horizontal line. The third image-sensing device captures images of the rectangular area from a third direction to produce a third image signal, wherein the third image-sensing device is disposed on the first side of the first edge of the rectangular area. The fourth image-sensing device captures images of the rectangular area from a fourth direction to produce a fourth image signal, wherein the fourth image-sensing device is disposed on the first side of the first edge of the rectangular area. The third image-sensing device and the fourth image-sensing device are disposed on a second horizontal line, and there is a first distance between the first horizontal line and the second horizontal line. The computing device detects a touch event occurring on the rectangular area according to two of the first image signal, the second image signal, the third image signal, and the fourth image signal.

Furthermore, another aspect of the present invention provides an optical sensing method applied to an optical sensing electronic device, wherein the optical sensing electronic device comprises a first image-sensing device, a second image-sensing device, and a third image-sensing device and a fourth image-sensing device. The optical sensing method includes: capturing images of a rectangular area from a first direction to produce a first image signal using the first image-sensing device, wherein the rectangular area has four edges, each of the edges has two sides, the first image-sensing device is disposed on a first side of a first edge of the rectangular area; capturing images of the rectangular area from a second direction to produce a second image signal using the second image-sensing device, wherein the second image-sensing device is disposed on the first side of the first edge of the rectangular area, and the first image-sensing device and the second image-sensing device are disposed on a first horizontal line; capturing images of the rectangular area from a third direction to produce a third image signal using the third image-sensing device, wherein the third image-sensing device is disposed on the first side of the first edge of the rectangular area; capturing images of the rectangular area from a fourth direction to produce a fourth image signal using the fourth image-sensing device, wherein the fourth image-sensing device is disposed on the first side of the first edge of the rectangular area, the third image-sensing device and the fourth image-sensing device are disposed on a second horizontal line, and a first distance is between the first horizontal line and the second horizontal line; and detecting a touch event occurs on the rectangular area according to two of the first image signal, the second image signal, the third image signal and the fourth image signal.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of an optical sensing electronic device of an exemplary embodiment;

FIG. 2 is a schematic diagram illustrating an embodiment of an optical sensing operation of an exemplary embodiment;

FIG. 3 is a schematic diagram illustrating an embodiment of a triangulation algorithm of an exemplary embodiment;

FIG. 4 is a schematic diagram illustrating an embodiment of the density of anchor points of an exemplary embodiment;

FIG. 5 is a schematic diagram illustrating another embodiment of an optical sensing electronic device of an exemplary embodiment;

FIG. 6 is a schematic diagram illustrating another embodiment of an optical sensing electronic device of an exemplary embodiment;

FIG. 7 is a schematic diagram illustrating an embodiment of an optical sensing operation of an exemplary embodiment;

FIG. 8 is a schematic diagram illustrating another embodiment of the density of anchor points of an exemplary embodiment;

FIG. 9 is a flowchart of an optical sensing method according to an embodiment of the present invention; and

FIG. 10 is a flowchart of an optical sensing method according to another embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

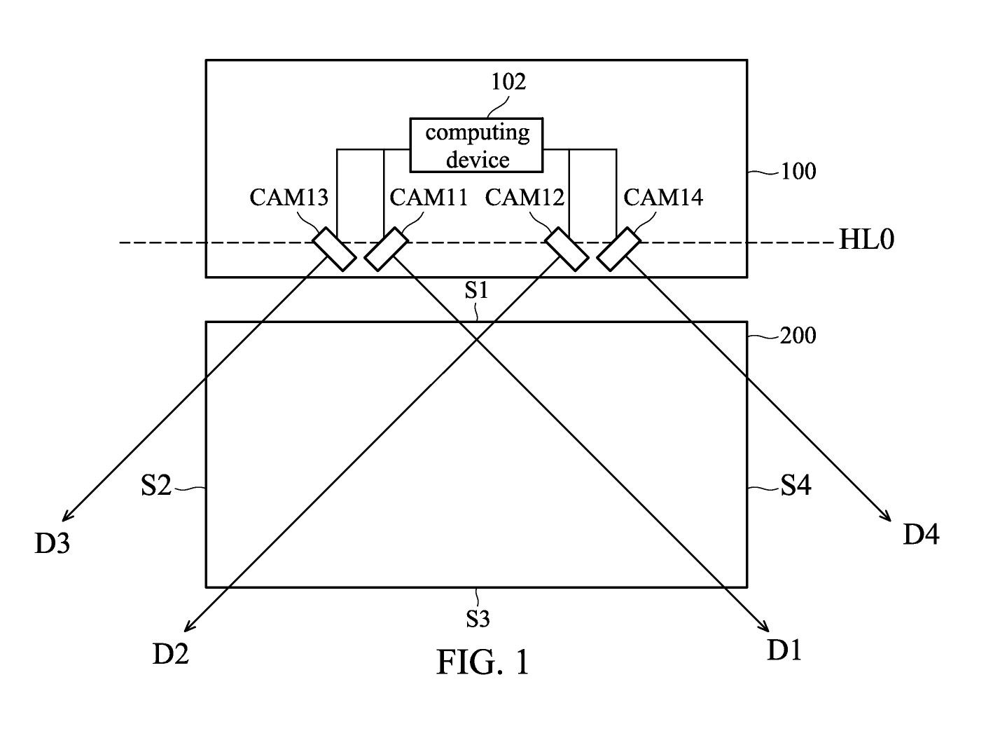

FIG. 1 is a schematic diagram illustrating an embodiment of an optical sensing electronic device of an exemplary embodiment. FIG. 1 includes an optical sensing electronic device 100 and a rectangular area 200. The optical sensing electronic device 100 is arranged to detect the touch events on the rectangular area 200. The rectangular area 200 has four edges S1, S2, S3 and S4. Each of the edges S1-S2, S3 and S4 has two sides, wherein the first side is on the outer periphery of the rectangular area 200, the second side is on the inner periphery of the rectangular area 200. The optical sensing electronic device 100 includes a first image-sensing device CAM11, a second image-sensing device CAM12, a third image-sensing device CAM13, a fourth image-sensing device CAM14 and a computing device 102. The first image-sensing device CAM11, the second image-sensing device CAM12, the third image-sensing device CAM13 and the fourth image-sensing device CAM14 are disposed on the first side S1 of the rectangular area 200 and on a horizontal line HL0. It should be noted that the horizontal line HL0 is a virtual line arranged to be a reference of relative positions. Namely, the horizontal line HL0 is not a physical line.

The first image-sensing device CAM11 is arranged to capture images on the rectangular area 200 from a first direction D1 to produce a first image signal. The second image-sensing device CMA12 is arranged to capture images on the rectangular area 200 from a second direction D2 to produce a second image signal. The third image-sensing device CMA13 is arranged to capture images on the rectangular area 200 from a third direction D3 to produce a third image signal. The fourth image-sensing device CMA14 is arranged to capture images on the rectangular area 200 from a fourth direction D4 to produce a fourth image signal. It should be noted that the first image-sensing device CAM11, the second image-sensing device CAM12, the third image-sensing device CAM13 and the fourth image-sensing device CAM14 receive optical signals in a visual angle limited by the physical characteristics of the image-sensing device along the first direction D1, the second direction D2, the third direction D3 and the fourth direction D4, respectively, to capture images on the rectangular area 200. Moreover, the visual angle is determined by the specification of the image-sensing device, but it is not limited thereto. For example, the visual angle can be 30°, 60°, 90° or 94°, etc., but it is not limited thereto.

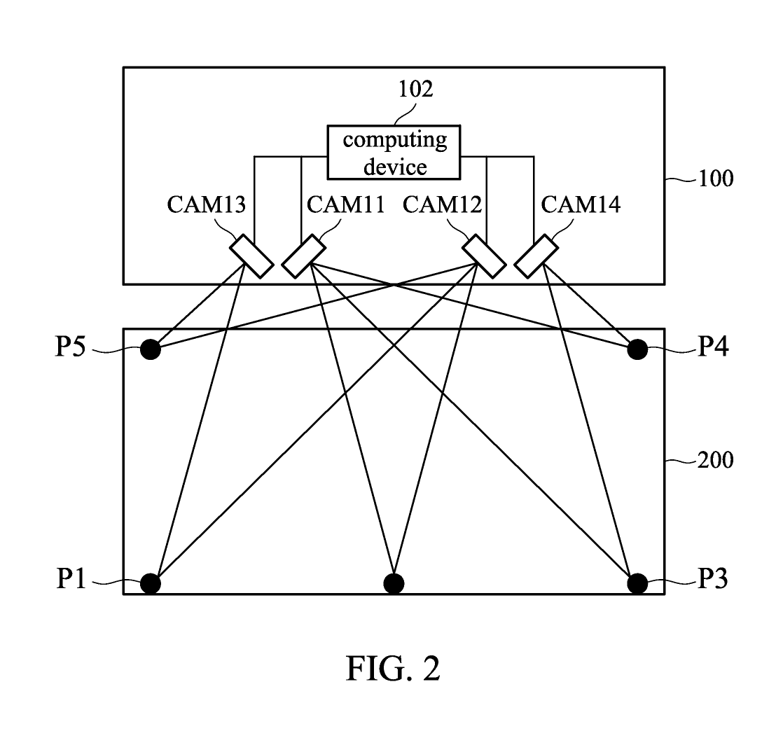

As shown in FIG. 2, any points in the rectangular area 200 can be covered by the visual angles of at least two of the first image-sensing device CAM11, the second image-sensing device CAM12, the third image-sensing device CAM13 and the fourth image-sensing device CAM14. For example, the optical signals on the point P1 which is at the corner of the rectangular area 200 can be detected by both the third image-sensing device CAM13 and the second image-sensing device CAM12. The optical signals on the point P3 which is at the corner of the rectangular area 200 can be detected by both the first image-sensing device CAM11 and the fourth image-sensing device CAM14. The optical signals on the point P4 which is at the corner of the rectangular area 200 can be detected by both the first image-sensing device CAM11 and the fourth image-sensing device CAM14. The optical signals on the point P5 which is at the corner of the rectangular area 200 can be detected by both the third image-sensing device CAM13 and the second image-sensing device CAM12. The optical signals on the point P2 which is at the midpoint of the edge S3 can be detected by both the first image-sensing device CAM11 and the second image-sensing device CAM12. As described above, users can put the optical sensing electronic device 100 anywhere only if every point in the rectangular area 200 can be covered by the visual angles of any two of the first image-sensing device CAM11, the second image-sensing device CAM12, the third image-sensing device CAM13 and the fourth image-sensing device CAM14. Moreover, the range of the rectangular area 200 is not limited only if every point in the rectangular area 200 can be covered by the visual angles of any two of the first image-sensing device CAM11, the second image-sensing device CAM12, the third image-sensing device CAM13 and the fourth image-sensing device CAM14.

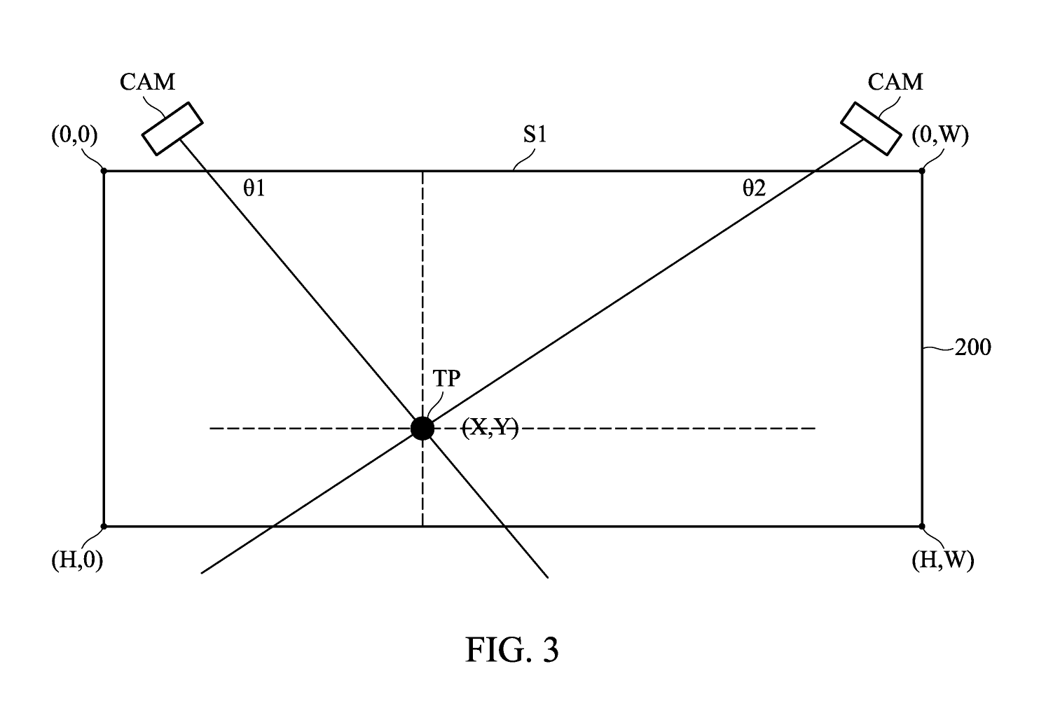

The computing device 102 is arranged to detect the touch event occurring on the rectangular area 200 according to any two of the first image signal produced by the first image-sensing device CAM11, the second image signal produced by the second image-sensing device CAM12, the third image signal produced by the third image-sensing device CAM13, and the fourth image signal produced by the fourth image-sensing device CAM14. The optical sensing of the present invention uses the triangulation algorithm to determine the position of a touch event TP occurring on the rectangular area 200, and the details can be found in FIG. 3, which is a schematic diagram illustrating an embodiment of a triangulation algorithm of an exemplary embodiment. FIG. 3 includes two image-sensing devices, wherein the two image-sensing devices CAM can be two of either the first image-sensing device CAM11, the second image-sensing device CAM12, the third image-sensing device CAM13 and the fourth image-sensing device CAM14 which can observe the same touch event TP. Moreover, in this embodiment, the rectangular area 200 has a width W and a height H, wherein (0,0) is the zero point of the coordinates of the rectangular area 200. The position of the touch event TP requires two different image-sensing devices CAM to be determined by the triangulation algorithm. As shown in FIG. 2, the computing device 102 can obtain a angle θ1 between the line constituted by one of the image-sensing devices CAM and touch event TP and the line of the first edge S1 and obtain the angleθ2 between the line constituted by the other image-sensing devices CAM and touch event TP and the line of the first edge S1 according to the image signals produced by the image-sensing devices CAM. Next, the computing device 102 can obtain the coordinates (X,Y) of the touch event TP using equation (1) and equation (2) of the triangulation algorithm, as shown below:

$$\begin{matrix}X = \frac{W \times tan θ 2}{tan θ 1 + tan θ 2} & equation ( 1 ) \\ Y = X \times tan ( θ 1 ) & equation ( 2 )\end{matrix}$$

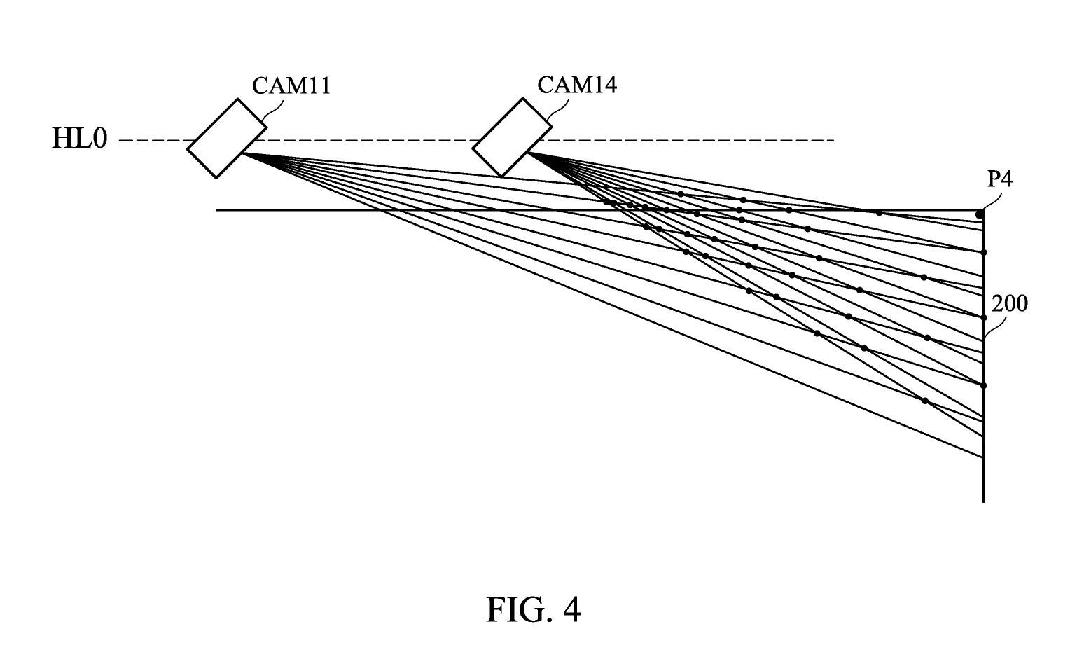

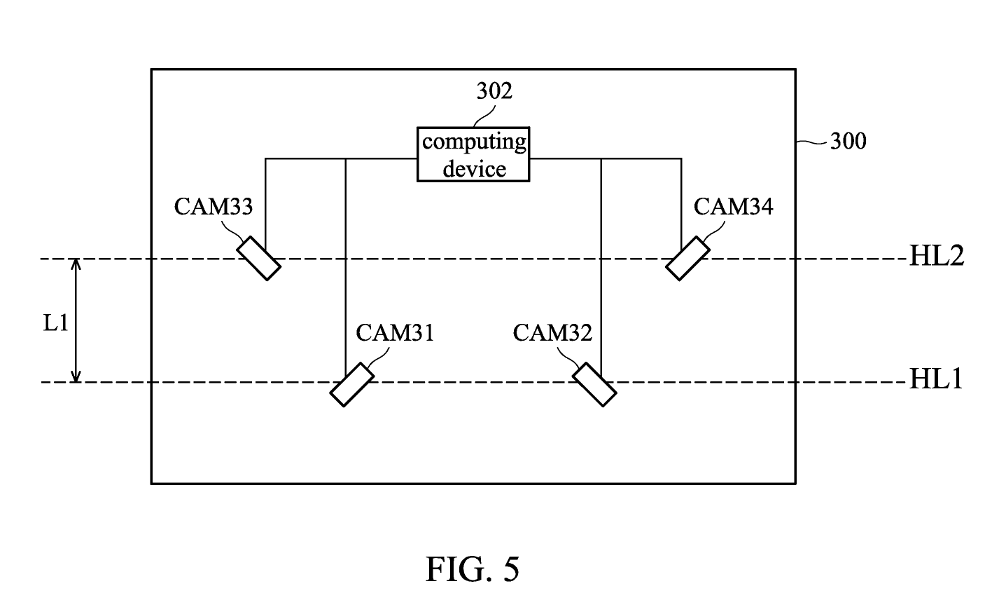

FIG. 4 is a schematic diagram illustrating an embodiment of the density of anchor points of an exemplary embodiment. FIG. 4 illustrates a plurality of anchor points of the optical sensing electronic device 100 on the corner of the rectangular area 200. More specifically, the resolution of the image captured by the image-sensing device is limited, such that the image-sensing device is unable to identify two points that are closer than a specific value on the rectangular area 200. Each of the lines stretch from the image-sensing devices of FIG. 4 corresponds to a photosensitive element of the first image-sensing device CAM11 or the fourth image-sensing device CAM14, wherein the photosensitive element can be a photosensitive diode or a photosensitive resistor, etc., but it is not limited thereto. Each of the intersections of two lines is an anchor point. The computing device 102 can accurately detect the position of the touch event TP when the touch event TP is on the anchor point. As shown in FIG. 4, the density of the anchor points is low around the area of the point P4 which is at the corner of the rectangular area 200. Therefore, the computing device 102 cannot accurately determine the position of a touch event TP occurring on a point P4 which is at the corner of the rectangular area 200. Similarly, the computing device 102 also cannot determine the position of a touch event TP occurring on a point P5 at the corner of the rectangular area 200. Therefore, the present invention provides another optical sensing electronic device 300 with optical sensing electronic devices on two different horizontal lines to solve the problem of detecting the position on the corner, as shown in FIG. 5.

FIG. 5 is a schematic diagram illustrating another embodiment of an optical sensing electronic device of an exemplary embodiment. FIG. 5 includes an optical sensing electronic device 300. Like the optical sensing electronic device 100 of FIG. 1, the optical sensing electronic device 300 includes a first image-sensing device CAM31, a second image-sensing device CAM32, a third image-sensing device CAM33, a fourth image-sensing device CAM34 and a computing device 102. The difference is that the first image-sensing device CAM31 and the second image-sensing device CAM32 of the optical sensing electronic device 300 are disposed on a first horizontal line HL1, the third image-sensing device CAM33 and the fourth image-sensing device CAM34 optical sensing electronic device 300 are disposed on a second horizontal line HL2, and a first distance L1 is the difference between the first horizontal line HL1 and the second horizontal line HL2. In one embodiment, the first horizontal line HL1 is parallel to the second horizontal line HL2, but it is not limited thereto. it should be noted that the first horizontal line HL1 and the second horizontal line HL2 are virtual lines arranged to be a reference of the relative position. Namely, the first horizontal line HL1 and the second horizontal line HL2 are not physical lines.

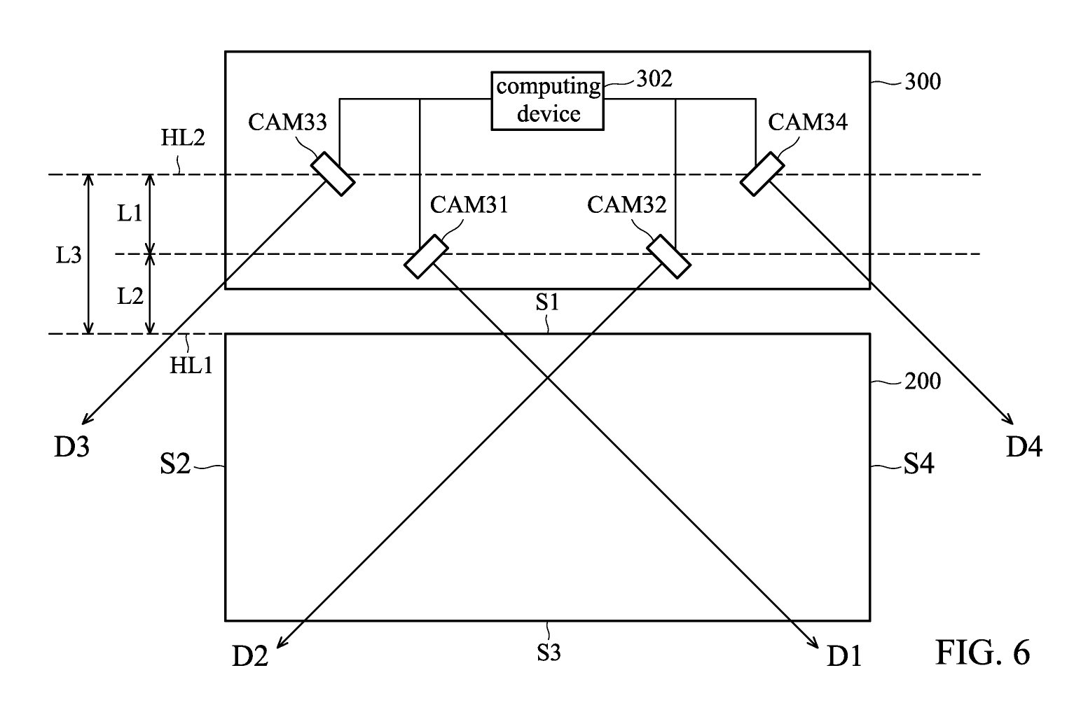

More specifically, as shown in FIG. 6, the first image-sensing device CAM31 is arranged to capture images on the rectangular area 200 from a first direction D1 to produce a first image signal. As shown in FIG. 1, the rectangular area 200 has four edges S1, S2, S3 and S4. Each of the edges has two sides, wherein the first side is on the outer periphery of the rectangular area 200, the second side is on the inner periphery of the rectangular area 200. The first image-sensing device CAM31 is disposed on the first side of the first edge S1 of the rectangular area 200. The second image-sensing device CAM32 is arranged to capture images on the rectangular area 200 from a second direction D2 to produce a second image signal, wherein the second image-sensing device CAM32 is also disposed on the first side of the first edge S1 of the rectangular area 200. The third image-sensing device CAM33 is arranged to capture images on the rectangular area 200 from a third direction D3 to produce a third image signal, wherein the third image-sensing device CAM33 is also disposed on the first side of the first edge S1 of the rectangular area 200. The fourth image-sensing device CAM34 is arranged to capture images on the rectangular area 200 from a fourth direction D4 to produce a fourth image signal, wherein the fourth image-sensing device CAM34 is also disposed on the first side of the first edge S1 of the rectangular area 200. In one embodiment, the first direction D1 is parallel to the fourth direction D4, and the second direction D2 is parallel to the third direction D3, but it is not limited thereto. It should be noted that the first image-sensing device CAM31, the second image-sensing device CAM32, the third image-sensing device CAM33 and the fourth image-sensing device CAM34 receive optical signals in a visual angle limited by the physical characteristics of the image-sensing device along the first direction D1, the second direction D2, the third direction D3 and the fourth direction D4, respectively, to capture images on the rectangular area 200. Moreover, the visual angle is determined by the specification of the image-sensing device, but it is not limited thereto. For example, the visual angle can be 30°, 60°, 90° or 94°, etc., but it is not limited thereto. Moreover, in one embodiment, the first horizontal line HL1 is parallel to the first edge S1 of the rectangular area 200, and the second horizontal line HL2 is parallel to the first edge S1 of the rectangular area 200, but it is not limited thereto. A first distance L1 is the difference between the first horizontal line HL1 and second horizontal line HL2, a second distance L2 is the difference between the first horizontal line HL1 and the first edge S1 of the rectangular area 200, a third distance L3 which is greater than the second distance L2 is the difference between the second horizontal line HL2 and the first edge S1 of the rectangular area 200. It should be noted that the first distance L1 is greater than 0, and the second distance L2 is also greater than zero. In other embodiments, the first horizontal line HL1, the second horizontal line HL2 and the first edge S1 can be lines not parallel to each other, but a difference in height must between the first image-sensing device and the third image-sensing device, and a difference in height must between the second image-sensing device CAM32 and the fourth image-sensing device CAM34.

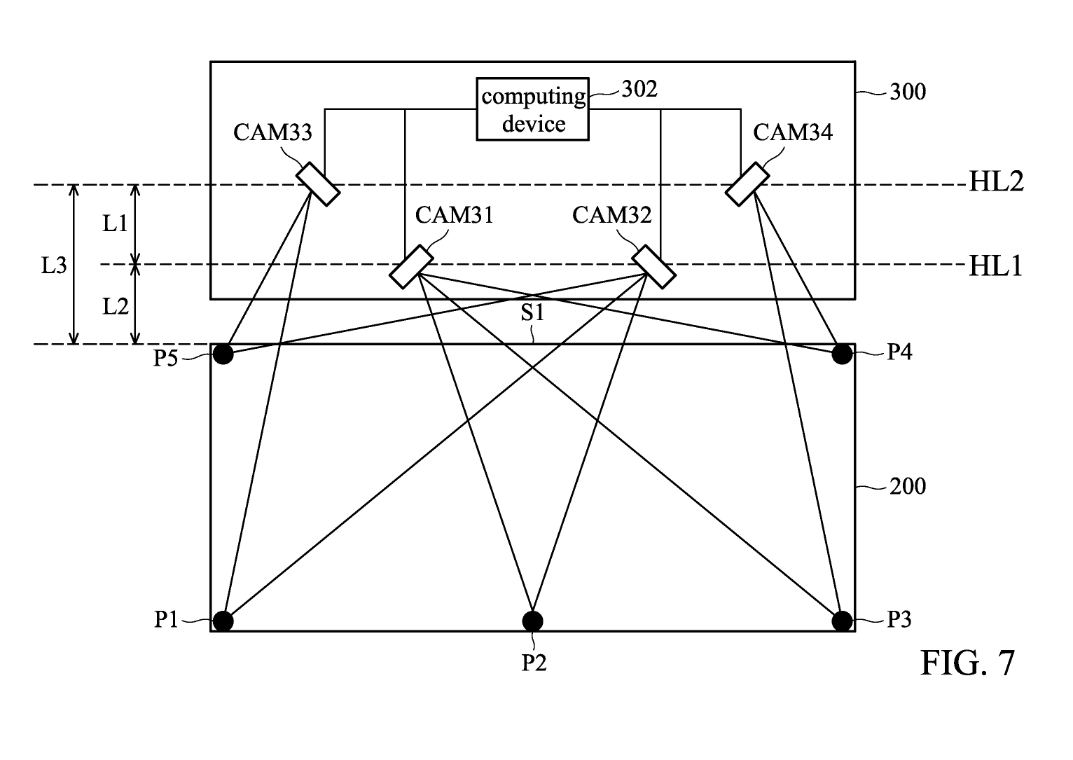

As shown in FIG. 7, every points in the rectangular area 200 can be covered by the visual angles of any two of the first image-sensing device CAM31, the second image-sensing device CAM32, the third image-sensing device CAM33 and the fourth image-sensing device CAM34. For example, the optical signals on the point P1 which is at a corner of the rectangular area 200 can be detected by both the third image-sensing device CAM33 and the second image-sensing device CAM32. The optical signals on the point P3 which is at the corner of the rectangular area 200 can be detected by both the first image-sensing device CAM31 and the fourth image-sensing device CAM34. The optical signals on the point P4 which is at the corner of the rectangular area 200 can be detected by both the first image-sensing device CAM31 and the fourth image-sensing device CAM34. The optical signals on the point P5 which is at the corner of the rectangular area 200 can be detected by both the third image-sensing device CAM33 and the second image-sensing device CAM32. The optical signals on the point P2 which is at the midpoint of the edge S3 can be detected by both the first image-sensing device CAM31 and the second image-sensing device CAM32. As described above, users can put the optical sensing electronic device 100 anywhere only if every point in the rectangular area 200 can be covered by the visual angles of any two of the first image-sensing device CAM31, the second image-sensing device CAM32, the third image-sensing device CAM33 and the fourth image-sensing device CAM34. Moreover, the range of the rectangular area 200 is not limited only if every point in the rectangular area 200 can be covered by the visual angles of any two of the first image-sensing device CAM31, the second image-sensing device CAM32, the third image-sensing device CAM33 and the fourth image-sensing device CAM34. In one of the embodiments of the present invention, the first distance L1 is determined by the second distance L2, and the first distance L1 is equal to the second distance L2, but it is not limited thereto. For example, the first distance L1 and the second distance L2 are 5 cm when the rectangular area 200 is a 92 inch area (190 cm×120 cm), the first image-sensing device CAM31 is 34 cm from the second image-sensing device CAM32, and the third image-sensing device CAM33 is 40 cm from the fourth image-sensing device CAM3, but it is not limited thereto. People will skill in the art can design the values of the first distance L1 and the second distance L2 according to the size of the rectangular area 200. Moreover, users can put the optical sensing electronic device 300 anywhere on the edge of the rectangular area 200, such that the second distance L2 is determined by the first distance L1.

The computing device 302 is arranged to detect a touch event occurring on the rectangular area 200 according to any two of the first image signal produced by the first image-sensing device CAM31, the second image signal produced by the second image-sensing device CAM32, the third image signal produced by the third image-sensing device CAM33, and the fourth image signal produced by the fourth image-sensing device CAM34. More specifically, the computing device 302 is arranged to select two of the first image signal, the second image signal, the third image signal and the fourth image signal which has detected the touch event, and determine the position of the touch event according to the selected image signal using the triangulation algorithm. The optical sensing of the present invention uses the triangulation algorithm to determine the position of a touch event TP occurring on the rectangular area 200, and the details can be found in FIG. 3.

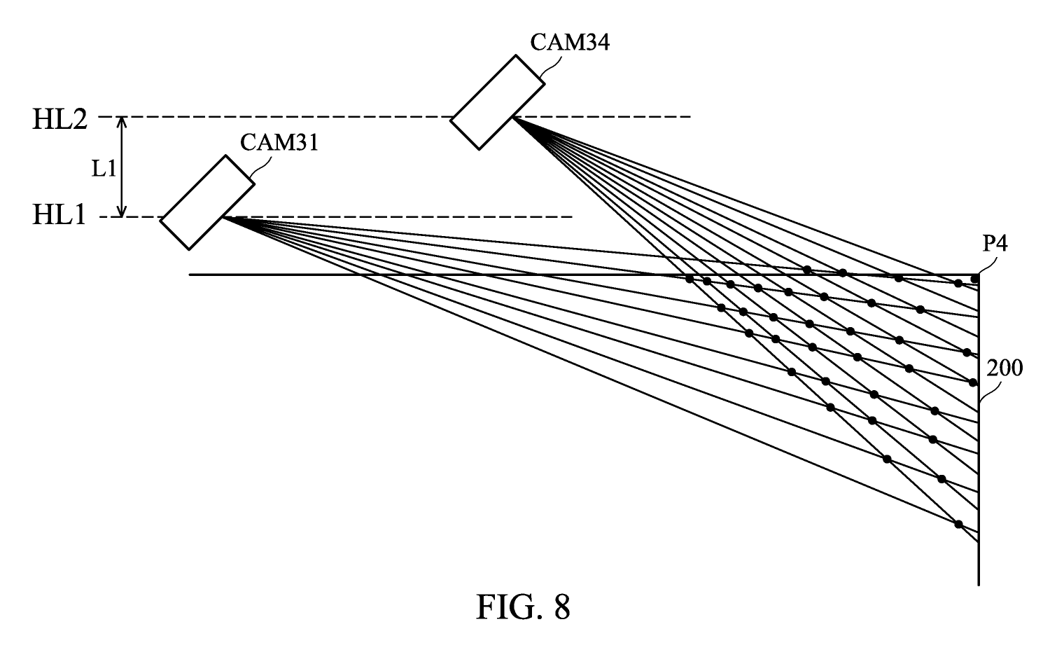

FIG. 8 is a schematic diagram illustrating another embodiment of the density of anchor points of an exemplary embodiment. FIG. 8 illustrates a plurality of anchor points of the optical sensing electronic device 300 of FIG. 7 on the corner of the rectangular area 200. More specifically, the resolution of the image captured by the image-sensing device is limited, such that the image-sensing device is unable to identify two points that are closer than a specific value on the rectangular area 200. Each of the lines stretch from the image-sensing devices of FIG. 8 corresponds to a photosensitive element of the first image-sensing device CAM31 or the fourth image-sensing device CAM34, wherein the photosensitive element can be a photosensitive diode or a photosensitive resistor, etc., but it is not limited thereto. Each of the intersections of two lines is an anchor point. The computing device 302 can accurately detect the position of the touch event TP when the touch event TP is on the anchor point. The anchor points around the point P4 which is at the corner of the rectangular area 200 of the optical sensing electronic device 300 of FIG. 8 are more evenly distributed in a densely fashion than the anchor points shown in FIG. 4. As described above, the computing device 302 of the optical sensing electronic device 300 can accurately determine the position of the touch event TP on the corner of point P4 of the rectangular area 200 using the arrangement of the image-sensing devices. Similarly, the computing device 102 can also accurately determine the position of the touch event TP on the corner of point P5 of the rectangular area 200.

In another embodiment, the computing device 302 is further arranged to determine a reference position of the first edge S1 of the rectangular area 200 according to the first image signal, the second image signal, the third image signal and the fourth image signal, and adjust at least one of the first distance L1 and the second distance L2 according to the reference position of the first edge S1. More specifically, the optical sensing electronic device 300 further includes a first mechanism device arranged to adjust the position of the third image-sensing device CAM33 and the fourth image-sensing device CAM34 to adjust the first distance L1, but it is not limited thereto. in another embodiment, the optical sensing electronic device 300 further includes a second mechanism device arranged to adjust the position of the first image-sensing device CAM31 and the second image-sensing device CAM32 to adjust the first distance L1 and the second distance L2. The first mechanism device and the second mechanism device can be constituted by mechanical arm, gear, track and other mechanism elements arranged to adjust the position of the first image-sensing device CAM31, the second image-sensing device CAM32, the third image-sensing device CAM33 and/or the fourth image-sensing device CAM34. Namely, the computing device 302 is further arranged to determine the reference position of the first edge S1 of the rectangular area 200 according to the first image signal, the second image signal the third image signal and the fourth image signal, and determine the second distance L2 according to the reference position of the first edge S1. Next, the computing device 302 determines the first distance L1 which can make a better distribution of the anchor points according to the second distance L2, and enables the first mechanism device and/or the second mechanism device to adjust at least one of the first distance L1 and the second distance L2.

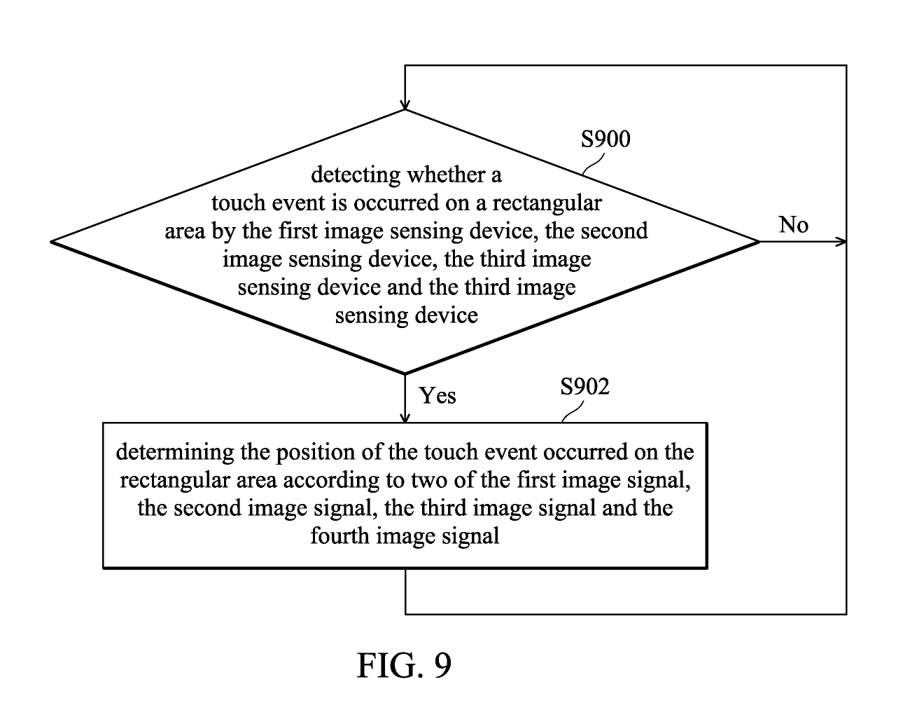

FIG. 9 is a flowchart of an optical sensing method according to an embodiment of the present invention. The optical sensing method is applied to the optical sensing electronic device 300 of FIG. 5. The process starts at step S900.

In step S900, the computing device 302 is arranged to detect whether a touch event has occurred on a rectangular area 200 using the first image-sensing device CAM31, the second image-sensing device CAM32, the third image-sensing device CAM33 and the third image-sensing device CAM33. When a touch event is occurring on the rectangular area 200, the process goes to step S902, otherwise, the computing device 302 continues to detect whether a touch event is occurring on the rectangular area 200 using the first image-sensing device CAM31, the second image-sensing device CAM32, the third image-sensing device CAM33 and the third image-sensing device CAM33. More specifically, the first image-sensing device CAM31 is arranged to capture images on the rectangular area 200 from a first direction D1 to produce a first image signal. The second image-sensing device CAM32 is arranged to capture images on the rectangular area 200 from a second direction D2 to produce a second image signal. The third image-sensing device CAM33 is arranged to capture images on the rectangular area 200 from a third direction D3 to produce a third image signal. The fourth image-sensing device CAM34 is arranged to capture images on the rectangular area 200 from a fourth direction D4 to produce a fourth image signal. It should be noted that the first image-sensing device CAM31, the second image-sensing device CAM32, the third image-sensing device CAM33 and the third image-sensing device CAM33 are disposed on one side of the first edge S1 of the rectangular area 200, as shown in FIG. 7. The first image-sensing device CAM31 and the second image-sensing device CAM32 of the optical sensing electronic device 300 are disposed on a first horizontal line HL1, the third image-sensing device CAM33 and the fourth image-sensing device CAM34 optical sensing electronic device 300 are disposed on a second horizontal line HL2, and a first distance L1 is the difference between the first horizontal line HL1 and the second horizontal line HL2. In one embodiment, the first direction D1 is parallel to the fourth direction D4, and the second direction D2 is parallel to the third direction D3, but it is not limited thereto. It should be noted that the first image-sensing device CAM31, the second image-sensing device CAM32, the third image-sensing device CAM33 and the fourth image-sensing device CAM34 receive optical signals in a visual angle limited by the physical characteristics of the image-sensing device along the first direction D1, the second direction D2, the third direction D3 and the fourth direction D4, respectively, to capture images on the rectangular area 200. Moreover, the visual angle is determined by the specification of the image-sensing device, but it is not limited thereto. For example, the visual angle can be 30°, 60°, 90° or 94°, etc., but it is not limited thereto.

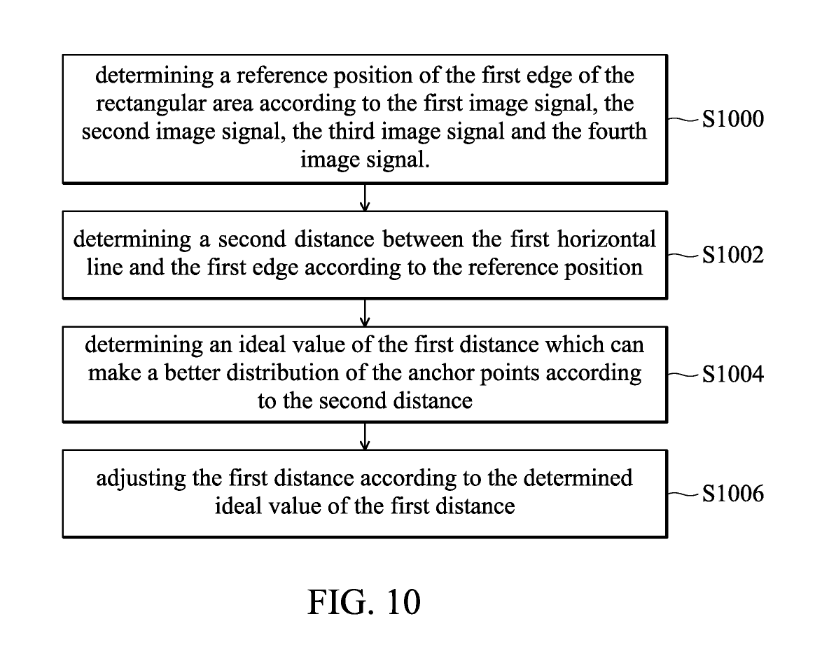

In one of the embodiments, the first horizontal line HL1 is parallel to the first edge S1 of the rectangular area 200, and the second horizontal line HL2 is parallel to the first edge S1 of the rectangular area 200, but it is not limited thereto. A first distance L1 is the difference between the first horizontal line HL1 and second horizontal line HL2, a second distance L2 is the difference between the first horizontal line HL1 and the first edge S1 of the rectangular area 200, a third distance L3 which is greater than the second distance L2 is the difference between the second horizontal line HL2 and the first edge S1 of the rectangular area 200. It should be noted that the first distance L1 is greater than 0, and the second distance L2 is also greater than zero. Moreover, the computing device 302 can determine the first distance L1 according to the second distance L2, the details can be found in FIG. 10. In other embodiments, the first horizontal line HL1, the second horizontal line HL2 and the first edge S1 can be lines not parallel to each other, but a difference in height must between the first image-sensing device and the third image-sensing device, and a difference in height must between the second image-sensing device CAM32 and the fourth image-sensing device CAM34.

In step S902, the computing device 302 is arranged to determine the position of a touch event occurring on the rectangular area 200 according to any two of the first image signal produced by the first image-sensing device CAM31, the second image signal produced by the second image-sensing device CAM32, the third image signal produced by the third image-sensing device CAM33 and the fourth image signal produced by the fourth image-sensing device CAM34. More specifically, the computing device 302 is arranged to select two of the first image signal, the second image signal, the third image signal and the fourth image signal which has detected the touch event, and determine the position of the touch event according to the selected image signal using the triangulation algorithm. The optical sensing of the present invention uses the triangulation algorithm to determine the position of a touch event TP occurring on the rectangular area 200, and the details can be found in FIG. 3. Next, the process returns to step S900, the computing device 302 continues to detect whether a touch event is occurring on the rectangular area 200 using the first image-sensing device CAM31, the second image-sensing device CAM32, the third image-sensing device CAM33 and the third image-sensing device CAM33.

FIG. 10 is a flowchart of an optical sensing method according to another embodiment of the present invention. The optical sensing method is applied to the optical sensing electronic device 300 of FIG. 5. The process starts at step S1000.

In step S1000, the computing device 302 determines a reference position of the first edge S1 of the rectangular area 200 according to the first image signal, the second image signal, the third image signal and the fourth image signal.

Next, in step S1002, computing device 302 determines a second distance L2 between the first horizontal line HL1 and the first edge S1 according to the reference position.

Next, in step S1004, the computing device 302 determines a ideal value of the first distance L1 which can make a better distribution of the anchor points according to the second distance L2.

Next, in step S1006, the computing device 302 enable the first mechanism device and/or the second mechanism device to adjust the first distance L1 according to the determined ideal value of the first distance L1. The process ends at step S1004. It should be noted that, in other embodiments, the computing device 302 can also adjust the second distance L2 to obtain a better distribution of the anchor points using the second mechanism device.

The optical sensing electronic device and the optical sensing method of the present invention have a better distribution of the anchor points on the corner of the detected area, such that the optical sensing electronic device and the optical sensing method of the present invention can accurately determine the position of touch event on the corner.

Data transmission methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical sensing electronic device, comprising:
a first image-sensing device, capturing images of a rectangular area from a first direction to produce a first image signal, wherein the rectangular area has four edges, each of the edges has two sides, and the first image-sensing device is disposed on a first side of a first edge of the rectangular area;
a second image-sensing device, capturing images of the rectangular area from a second direction to produce a second image signal, wherein the second image-sensing device is disposed on the first side of the first edge of the rectangular area, and the first image-sensing device and the second image-sensing device are disposed on a first horizontal line;
a third image-sensing device, capturing images of the rectangular area from a third direction to produce a third image signal, wherein the third image-sensing device is disposed on the first side of the first edge of the rectangular area;
a fourth image-sensing device, capturing images of the rectangular area from a fourth direction to produce a fourth image signal, wherein the fourth image-sensing device is disposed on the first side of the first edge of the rectangular area, the third image-sensing device and the fourth image-sensing device are disposed on a second horizontal line, and a first distance is between the first horizontal line and the second horizontal line; and
a computing device, detecting a touch event occurring on the rectangular area according to two of the first image signal, the second image signal, the third image signal and the fourth image signal.

2. The optical sensing electronic device as claimed in claim 1, wherein the first horizontal line is parallel to the first edge of the rectangular area, and the second horizontal line is parallel to the first edge of the rectangular area.

3. The optical sensing electronic device as claimed in claim 1, wherein the first direction is parallel to the fourth direction, and the second direction is parallel to the third direction.

4. The optical sensing electronic device as claimed in claim 1, wherein the computing device selects two of the first image signal, the second image signal, the third image signal and the fourth image signal which has detected the touch event, and determines a position of the touch event using a triangulation algorithm according to the two selected first image signal, second image signal, third image signal or fourth image signal.

5. The optical sensing electronic device as claimed in claim 1, wherein a second distance is between the first horizontal line and the first edge of the rectangular area, a third distance greater than the second distance is between the second horizontal line and the first edge of the rectangular area, and the first distance is determined by the second distance.

6. The optical sensing electronic device as claimed in claim 5, wherein the first distance and the second distance are equal, and the first distance and the second distance are greater than zero.

7. The optical sensing electronic device as claimed in claim 5, wherein the computing device determines a reference position of the first edge of the rectangular area using the first image signal, the second image signal, the third image signal and the fourth image signal and adjusts at least one of the first distance and the second distance according to the reference position.

8. The optical sensing electronic device as claimed in claim 7, further comprising a first mechanism device arranged to move the third image-sensing device and the fourth image-sensing device to adjust the first distance.

9. The optical sensing electronic device as claimed in claim 7, further comprising a second mechanism device arranged to move the first image-sensing device and the second image-sensing device to adjust the first distance and the second distance.

10. An optical sensing method, applied to an optical sensing electronic device, wherein the optical sensing electronic device comprises a first image-sensing device, a second image-sensing device, a third image-sensing device and a fourth image-sensing device, the optical sensing method comprising:
capturing images of a rectangular area from a first direction to produce a first image signal using the first image-sensing device, wherein the rectangular area has four edges, each of the edges has two sides, the first image-sensing device is disposed on a first side of a first edge of the rectangular area;
capturing images of the rectangular area from a second direction to produce a second image signal using the second image-sensing device, wherein the second image-sensing device is disposed on the first side of the first edge of the rectangular area, and the first image-sensing device and the second image-sensing device are disposed on a first horizontal line;
capturing images of the rectangular area from a third direction to produce a third image signal using the third image-sensing device, wherein the third image-sensing device is disposed on the first side of the first edge of the rectangular area;
capturing images of the rectangular area from a fourth direction to produce a fourth image signal using the fourth image-sensing device, wherein the fourth image-sensing device is disposed on the first side of the first edge of the rectangular area, the third image-sensing device and the fourth image-sensing device are disposed on a second horizontal line, and a first distance is between the first horizontal line and the second horizontal line; and
detecting a touch event occurring on the rectangular area according to two of the first image signal, the second image signal, the third image signal or the fourth image signal.

11. The optical sensing method as claimed in claim 10, wherein the first horizontal line is parallel to the first edge of the rectangular area, and the second horizontal line is parallel to the first edge of the rectangular area.

12. The optical sensing method as claimed in claim 10, wherein the first direction is parallel to the fourth direction, and the second direction is parallel to the third direction.

13. The optical sensing method as claimed in claim 10, wherein the step of detecting the touch event occurring on the rectangular area according to two of the first image signal, the second image signal, the third image signal and the fourth image signal further comprises selecting two of the first image signal, the second image signal, the third image signal and the fourth image signal which has detected the touch event and determining a position of the touch event by a triangulation algorithm according to the two selected first image signal, second image signal, third image signal or fourth image signal.

14. The optical sensing method as claimed in claim 10, wherein a second distance is between the first horizontal line and the first edge of the rectangular area, a third distance greater than the second distance is between the second horizontal line and the first edge of the rectangular area, and the optical sensing method further comprises determining the first distance according to the second distance.

15. The optical sensing method as claimed in claim 14, wherein the first distance and the second distance are equal, and the first distance and the second distance are greater than zero.

16. The optical sensing method as claimed in claim 14, further comprising:
determining a reference position of the first edge of the rectangular area using the first image signal, the second image signal, the third image signal and the fourth image signal; and
adjusting at least one of the first distance and the second distance according to the reference position.
